(19) United States
(12) Patent Application Publication
(10) Pub. No.: US 2005/0227670 A1
(43) Pub. Date: Oct. 13, 2005

(54) Methods and systems for providing voice over internet protocol communications via an intranet

(76) Inventor: Dennis Dale Bicker, San Ramon, CA (US)

Correspondence Address: HARNESS, DICKEY & PIERCE, P.L.C., P.O. BOX 8910, RESTON, VA, 20195, US

(21) Appl. No.: 10/819,175

(22) Filed: Apr. 7, 2004

(51) Int. Cl. H04M 1/66

(52) U.S. Cl. 455/411

(57) ABSTRACT

A method of providing Voice-over-Internet Protocol (VoIP) communications to a device outside an intranet includes receiving authentication data from the device and comparing the data to a list of authentication data. If the comparison results in a match, a connection is established between the device outside the intranet and the intranet using one or more tunneling protocols. Thereafter, a VoIP pathway may be established between the outside device and another device. Calls or connections over this pathway are not subject to pubic switched telephone network charges.

### BACKGROUND OF THE INVENTION

More and more devices are being designed to make use of a voice over Internet Protocol (VoIP) to carry out voice-based calls. For example, a VoIP capable telephone may be configured with software and hardware to convert signals representing a user's voice to an Internet Protocol (IP) signal, and vice-versa. In addition to communications over the Internet, VoIP telephones can be used to communicate over private networks called intranets that support IP signaling. One type of intranet is referred to as a virtual private network (VPN).

Communication between users within a VPN does not require access to a public switched telephone network (PSTN) even though some of these communications may traverse the Internet. However, a person using a VoIP device, e.g., telephone, outside the VPN must typically go through a PSTN to communicate with a person using a telephone and the like within the intranet. For example, where a company has set up a VPN, an employee who is remote from the company's main office may have to go through a PSTN to communicate with someone in the office in order to use her VoIP capable device. Such calls can be expensive and may also be susceptible to eavesdropping.

### SUMMARY OF THE INVENTION

The present invention is directed to methods and systems that provide VoIP communications via an intranet, such as a VPN, between a VoIP device (i.e., user of such a device) outside the intranet and another device within, or outside, the intranet. To provide such communications, authentication data is received from the VoIP device and compared to a list of authentication data. If the comparison results in a match, a connection (including tunneling) is established between the VoIP device and the intranet. Thereafter, a VoIP pathway is established between the VoIP device and the other device. Calls or connections over this pathway are not subject to PSTN charges.

### BRIEF DESCRIPTION OF THE DRAWINGS

FIG. 1 is a simplified block diagram of a communications network in accordance with one embodiment of the present invention;

FIG. 2 is a simplified flow diagram of a method of initializing a VoIP device in accordance with one embodiment of the present invention;

FIG. 3 is a flow diagram of a method of placing a VoIP call in accordance with one embodiment of the present invention; and

FIG. 4 is a flow diagram of a method of receiving a VoIP call in accordance with one embodiment of the present invention.

### DETAILED DESCRIPTION OF THE INVENTION

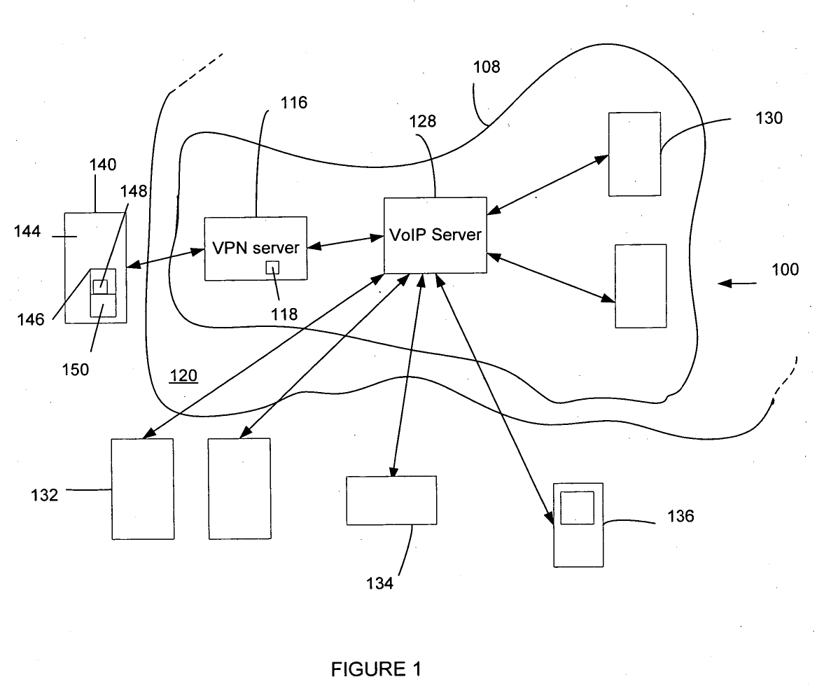

Referring now to FIG. 1, there is shown a communications network 100. The network 100 includes an intranet 108, which in the present embodiment may be a wide area network (WAN), VPN. In another embodiment of the present invention, the intranet 108 may comprise a local area network (LAN), VPN. The intranet 108 may include one or more servers 116. Although a single server 116 is shown in FIG. 1 for simplicity, it should be understood that server 116 may comprise additional servers for performing one or more of the features or functions described herein. The server 116 may include, for example, a VPN server that provides for the tunneling of data packets through the Internet 120 to and/or from the intranet 108.

The server 116 is in communication with a VoIP service provider or server 128 that provides VoIP connections for one or more devices 130 within the intranet 108, between a device 130 and VoIP devices 132-140 outside the intranet 108 or between various VoIP devices 132-140 outside the intranet 108. Such devices may include telephones connected to a public switched telephone network (PSTN) (not shown), wireless devices or personal communications services (PCS) devices. For the sake of simplicity, the devices 130-140 will assumed to be telephones though it should be understood that other devices capable of VoIP communications may be substituted in their place.

A VoIP telephone 140 may comprise a processor 144 having a memory. The processor 144 may comprise an authentication section 146 and a configuration section 150. The authentication section 146 may comprise, for example, SecurID® token software available from RSA Security Inc. The authentication section 146 may include, or have access to, a clock section 148. The clock section 148 may be operable to be set to the same time as a clock unit 118 associated with the server section 116. In one embodiment, the authentication section 146 is operable to generate new authentication data substantially identical to new authentication data generated by server 116. In yet a further embodiment of the present invention, the authentication section 146 and the server 116 may be operable to generate the new authentication data substantially simultaneously. In another embodiment, new data may be generated periodically (e.g., every sixty seconds).

The configuration section 150 may comprise hardware, firmware or software for establishing the phone 140 as a client of the intranet 108. The software may be, for example, Cisco® VPN Client available from Cisco Systems, Inc.

The server 116 and configuration section 150 may be operable to “negotiate” in order to establish the telephone 140 as a client of the intranet 108, and in order to establish a connection between the VoIP telephone 140 and the VoIP service provider 128.

Though the authentication section 146 and/or configuration section 150 may be hard-wired or programmed into the telephone 140, alternatively or additionally, at least one or more of the sections 146,150 may comprise programs, data and the like (collectively “programs”) that are downloaded into the telephone 140, for example, from one or more remote sources including, but not limited to, the server 116 over an Internet connection. The programs may be operable to execute a series of instructions to control and carry out the features and functions discussed above and below. The programs may be stored on, and executed by, a number of different computer readable mediums (e.g., microprocessor, digital signal processing memory, floppy disk, etc.).

Having presented some examples of the devices/elements that may make up the network 100 in FIG. 1, we now turn to some examples of their operation.

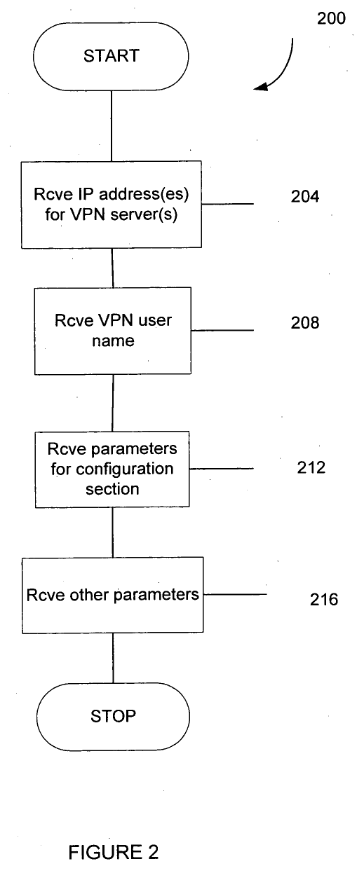

In a further embodiment of the present invention, the telephone 140 may be operable to receive instructions from a user to initialize the telephone 140 so that it may communicate through the intranet 108, using an initialization method indicated generally in FIG. 2 by reference number 200. The telephone 140 may be operable to receive instructions directly from a keypad on the telephone, or indirectly through a password-secured web interface built into the telephone.

At step 201 the telephone 140 may be operable to receive a server name or an IP address associated with the VPN server 116 from the user. The telephone 140 may further be operable to receive one or more additional server names or IP addresses of one or more servers configured to establish VPN tunneling from the user. At step 202 the telephone 140 may be operable to receive a VPN user name from the user.

At step 203 the telephone 140 may further be operable to present the user with options that allows the user to select and enter parameters associated with the configuration section 150 into the telephone 140. Such parameters may be used when so-called “tunneling” is established, and may indicate a type of transparent tunneling protocol that is to be enabled. Such tunneling protocols include, for example, IP Security Protocol (IPSec) over User Datagram Protocol (UDP) and/or IPSec over Transmission Control Protocol (TCP). The user may also select and enter parameters that, for example, indicate whether NAT/PAT (network-to-port address translation) is enabled. Where the user selects IPSec over TCP, a TCP port number also may be entered that allows tunneling past a firewall of the intranet 108. Other parameters entered into telephone 140 by the user at step 203 may include, but are not limited to, parameters for selecting a peer response timeout in seconds, a security group name, a security group password and/or whether access is to be enabled to a LAN of the intranet 108.

At step 204 the telephone 140 may yet further be operable to receive other or additional parameters from the user. Such parameters may include, for example, whether the telephone 140 is to be disconnected from the intranet 108 after each call and/or whether the authentication section 146 is to be used or disabled.

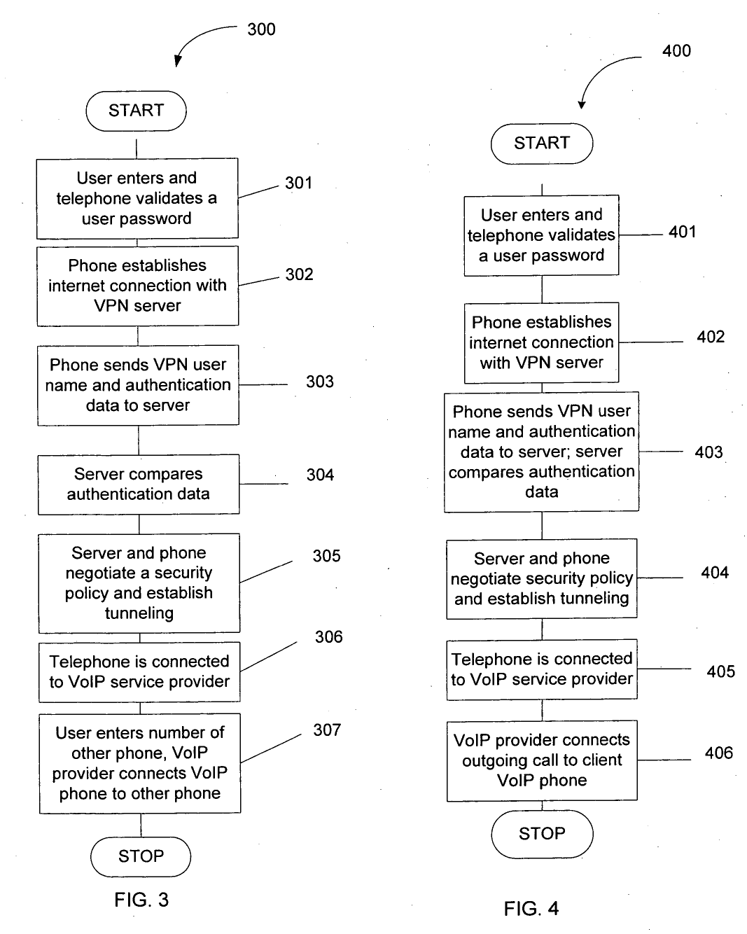

Once the telephone 140 has been initialized, a user of the telephone 140 may place a call through the intranet 108 to a number associated with another telephone. The other telephone may be a telephone 130 within the intranet 108, or telephones 132-136 outside the intranet 108. The user of the telephone 140 may place such a call using a method indicated generally by reference number 300 in FIG. 3. These calls are not subject to PSTN charges.

At step 301 the user may first be required to enter a passcode or the like into the telephone 140 to access the telephone 140. For example, the passcode may be entered by depressing a key (or key combination) on a keypad or the like of telephone 140. Assuming that the passcode entered is valid, the user is granted access to the telephone 140.

Assuming further that such a validation occurs, at step 302, the telephone 140 may be operable to establish a connection with the VPN server 116 via the Internet 120. At step 303 the telephone 140 is operable to send a VPN user name and authentication data to the server 116.

At step 304 the server 116 is operable to receive the authentication data and to compare the received data to a list of authentication data or codes associated with authorized users stored in the server 116.

When the comparison results in a match (i.e., the user is authorized to access intranet 108), then at step 305 the server 116 and telephone 140 via the configuration section 150 negotiate a security policy and establish transparent VPN tunneling between the server 116 and the telephone 140 and establish the telephone 140 as a client of the VPN server 116.

In one embodiment the VPN server 116 is operable to construct and operate a firewall in a layer different from the layer in which the VoIP service provider 128 provides VoIP service. As long as the telephone 140 remains a client of the VPN server 116, the firewall will allow a connection to be maintained between the telephone 140 and server 116. As a client of server 116, the telephone 140 is treated in the same or similar manner as other devices within the intranet 108. A connection may also be established between the telephone 140 and other intranet devices, e.g., to a LAN of the intranet 108 (provided appropriate tunneling, etc., parameter(s) are preset in the telephone 140 as previously described).

Once connected to the intranet 108, at step 306, the telephone 140 may register and become connected with the VoIP service provider 128. At step 307 a user may enter a telephone number to which the user seeks to be connected, into the telephone 140, for example, a number for the telephone 130 within the intranet 108. The VoIP service provider 128 is operable to receive the number from the telephone 140 and establish a VoIP pathway or connection between the telephone 140 and the appropriate telephone 130 or 132-136.

In yet another embodiment of the present invention, the telephone 140 may also be operable to receive calls through the intranet 108 using a method indicated generally by reference number 400 in FIG. 4. Such a call may originate from a telephone 130 within the intranet 108, or from telephones 132-136 outside the intranet 108, through the intranet 108, when, for example, the VoIP service provider 128 is configured to redirect calls received from outside the intranet 108.

In yet a further embodiment of the present invention, the telephone 140 may be operable to receive a prearranged call through the intranet 108. In another embodiment, the VoIP provider 128 may be operable to contact the telephone 140 to notify the user of such a call.

Referring again to FIG. 4, steps 401 through 405 are performed in the same or similar manner as steps 301 through 306 previously described with reference to FIG. 3. Thereafter, at step 406 the VoIP provider 128 may be operable to direct a call received from, for example, a telephone 136 to the telephone 140 through a connection established at step 404.

The foregoing provides some examples of how the present invention provides a way for a VoIP capable device initially outside an intranet to carry out VoIP telephone calls and the like through the intranet. This allows, for example, a company employee away from his or her office to communicate over a VoIP pathway through her company's VPN without incurring PSTN call charges.

The foregoing features and functions may be implemented, for example, by a VoIP service provider offering a telecommunications service that enables customers to use VoIP pathways on, for example, a temporary basis. The VoIP service provider (as well as VPN server) may include a number of programs operable to execute the features and functions described above. These programs may also be stored on a computer readable medium, examples of which were given previously above.

The above has set forth some examples of the present invention. The true scope of the present invention is better defined by the claims which follow.

1. A method of providing Voice-over-Internet Protocol (VoIP) communications to a device outside an intranet via the intranet comprising:
receiving authentication data from a device outside an intranet;
comparing the received authentication data to a list of authentication data; and
establishing a connection between the device outside the intranet and the intranet if the comparison results in a match,
wherein a VoIP pathway may be established between the device outside the intranet and another device after the connection is established.

2. The method as in claim 1 further comprising a telecommunications service operable to establish a VoIP pathway between the device outside the intranet and another device, wherein communications over such a pathway are not subject to public switched telephone network charges.

3. The method as in claim 1 further comprising a telecommunications service operable to establish a VoIP pathway between the device outside the intranet and another device.

4. The method as in claim 3 further comprising a telecommunications service operable to establish a VoIP pathway between the device outside the intranet and another device within the intranet.

5. The method as in claim 3 further comprising a telecommunications service operable to establish a VoIP pathway between the device outside the intranet and another device outside the intranet.

6. The method of claim 1 further comprising negotiating a security policy with the device outside the intranet.

7. The method of claim 1 further comprising downloading at least one of authentication and configuration programs into the device outside the intranet.

8. The method as in claim 1 further comprising generating new authentication data for the list substantially simultaneously as new data is generated by the device outside the intranet, wherein both sets of data are substantially identical.

9. The method as in claim 8 further comprising generating new authentication data for the list substantially periodically as new data is generated by the device outside the intranet, wherein both sets of data are substantially identical.

10. The method as in claim 1 wherein establishing the connection between the device outside the intranet and the intranet comprises establishing tunneling using one or more tunneling protocols.

11. The method as in claim 1 further comprising establishing a connection between the device outside the intranet and a local area network within the intranet if the comparison results in a match.

12. The method as in claim 1 wherein the intranet comprises a virtual private network.

13. A system for providing Voice-over-Internet Protocol (VoIP) communications to a device outside an intranet via the intranet comprising:
a virtual private network (VPN) server within the intranet operable to;
receive authentication data from a device outside an intranet,
compare the received authentication data to a list of authentication data, and
establish a connection with the device outside the intranet if the comparison results in a match,
wherein a VoIP pathway may be established between the device outside the intranet and another device after the connection is established.

14. The system as in claim 13 further comprising a VoIP server operable to establish a VoIP pathway between the device outside the intranet and another device, wherein communications over such a pathway are not subject to public switched telephone network charges.

15. The system as in claim 13 further comprising a VoIP server operable to establish a VoIP pathway between the device outside the intranet and another device.

16. The system as in claim 15 further comprising a VoIP server operable to establish a VoIP pathway between the device outside the intranet and another device within the intranet.

17. The system as in claim 15 further comprising a VoIP server operable to establish a VoIP pathway between the device outside the intranet and another device outside the intranet.

18. The system as in claim 13 further comprising a VoIP server operable to negotiate a security policy with the device outside the intranet.

19. The system as in claim 13 wherein the VPN server is further operable to download at least one of authentication and configuration programs into the device outside the intranet.

20. The system as in claim 13 wherein the VPN server is further operable to generate new authentication data for the list substantially simultaneously as new data is generated by the device outside the intranet, wherein both sets of new data are substantially identical.

21. The system as in claim 20 wherein the VPN server is further operable to generate new authentication data substantially periodically as new data is generated by the device outside the intranet, wherein both sets of new data are substantially identical.

22. The system as in claim 13 wherein the VPN server is further operable to establish the connection between the device outside the intranet and the intranet by establishing tunneling using one or more tunneling protocols.

23. The system as in claim 13 wherein the VPN server is further operable to establish a connection between the device outside the intranet and a local area network within the intranet if the comparison results in a match.

24. The system as in claim 13 wherein the intranet comprises a VPN.

25. A device outside an intranet capable of communicating with the intranet using Voice-over-Internet-Protocol (VoIP) operable to:
send authentication data to a virtual private network (VPN) server within the intranet;
establish tunneling with the server; and
establish a VoIP connection with the intranet.

26. The device as in claim 25 further operable to establish a VoIP connection with a device inside or outside the intranet, wherein the connection is not subject to public switched telephone network charges.

27. The device as in claim 25 further operable to establish a VoIP connection with a device outside the intranet.

28. The device as in claim 25 further operable to establish a VoIP connection with a device within the intranet.

29. The device as in claim 25 further operable to negotiate a security policy with a VoIP server.

30. The device as in claim 25 further operable to receive at least one of authentication and configuration programs from the VPN server.

31. A computer readable medium associated with a virtual private network (VPN) server within an intranet operable to control:
reception of authentication data from a device outside an intranet;
comparison of the received authentication data to a list of authentication data; and
establishment of a connection with the device outside the intranet and another device if the comparison results in a match,
wherein a VoIP pathway may be established between the device outside the intranet and the other device after the connection is established.

32. A computer readable medium associated with a Voice-over-Internet-Protocol (VoIP) server operable to control the establishment of a VoIP pathway between a device outside an intranet and another device, wherein communications over such a pathway are not subject to public switched telephone network charges.

33. A computer readable medium, associated with a device outside an intranet capable of communicating with the intranet using Voice-over-Internet-Protocol (VoIP), operable to control:
sending authentication data to a virtual private network (VPN) server within the intranet;
establishment of tunneling with the server; and
establishment of a VoIP connection with the intranet.

34. The computer readable medium as in claim 33 further operable to control the establishment of a VoIP connection with another device inside or outside the intranet, wherein the connection is not subject to public switched telephone network charges.
